(19) United States
(12) Patent Application Publication
(10) Pub. No.: US 2008/0029981 A1
(43) Pub. Date: Feb. 7, 2008

(54) Janitorial cleaning cart

(76) Inventor: Stephen A. Dukes, North Baltimore, OH (US)

Correspondence Address: FRASER CLEMENS MARTIN & MILLER LLC, 28366 KENSINGTON LANE, PERRYSBURG, OH, 43551, US

(21) Appl. No.: 11/499,037

(22) Filed: Aug. 4, 2006

(51) Int. Cl. B62B 3/00

(52) U.S. Cl. 280/47.35

(57) ABSTRACT

Janitorial cleaning carts, and more particularly cleaning carts capable to selectively receiving attachments for holding cleaning accessories such as mops, brooms, brushes, tools, and other related cleaning supplies.

### BACKGROUND OF THE INVENTION

1. Field of the Invention

The present invention relates to janitorial cleaning carts, and more particularly to cleaning carts capable to selectively receiving attachments for holding cleaning accessories such as mops, brooms, brushes, tools, and other related cleaning supplies.

2. Description of the Prior Art

Heretofore, cleaning carts have been produced wherein the carts were provided with pockets, shelves, and the like for containing cleaning articles and accessories. While such costs were generally useful, it has been determined that the storage and maintenance of other cleaning materials and accessories which were easily accessible by the user were required.

### SUMMARY OF THE INVENTION

It is an object of the present invention to produce a cleaning cart, particularly useful in the janitorial field, capable of selectively receiving attachments for holding cleaning accessories.

Another object of the present invention is to produce a cleaning cart for use in the janitorial field capable of selectively receiving attachments for holding cleaning accessories and related supplies.

Still another object of the invention is to produce a cleaning cart for use in the janitorial field having selectively removable attachments for holding cleaning accessories and supplies which are readily accessible by the user to facilitate the removal and subsequent replacement of the accessories and attendant supplies.

The above objects, as well as others, may be surprisingly achieved by a janitorial cleaning cart comprising a main body having a lower portion having ground engaging wheels and a spaced apart upper portion having a refuse bag retaining means and an associated receiving means for an accessory for removably maintaining cleaning supplies; and an accessory retaining attachment including a supporting bracket for selectively connecting to the accessory receiving means of the upper portion of the main body.

### BRIEF DESCRIPTION OF THE DRAWINGS

The above as well as other objects and advantages of the invention will become readily manifest to those skilled in the art from reading the following detailed description of a preferred embodiment of the invention when considered in the light of the accompanying drawings, in which:

FIG. 1 is a perspective view of a janitorial cleaning cart incorporating the features of the present invention; and

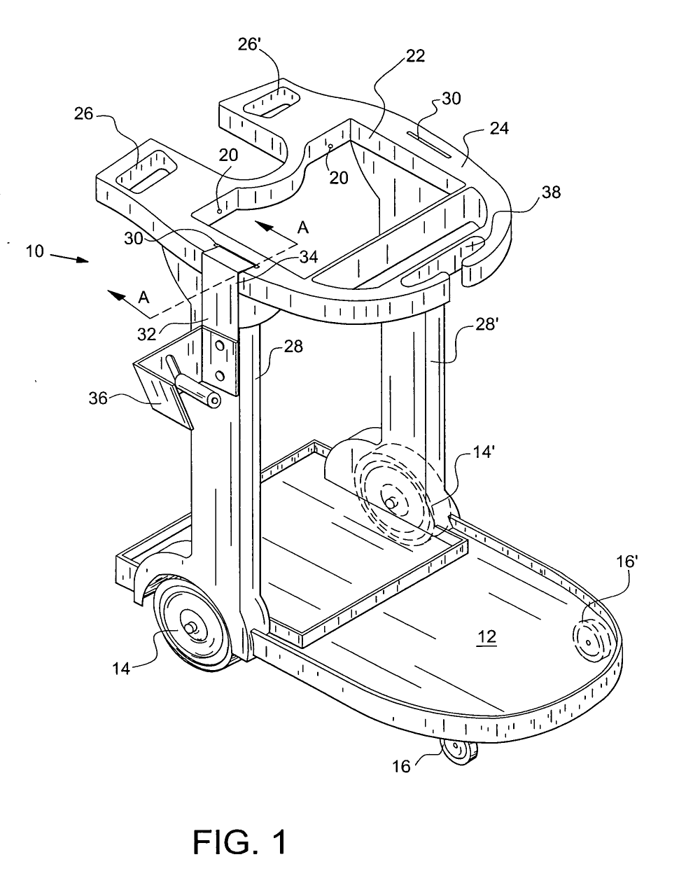

FIG. 2 is a fragmentary sectional view of an accessory retaining means for supporting cleaning accessories on the associated cleaning cart.

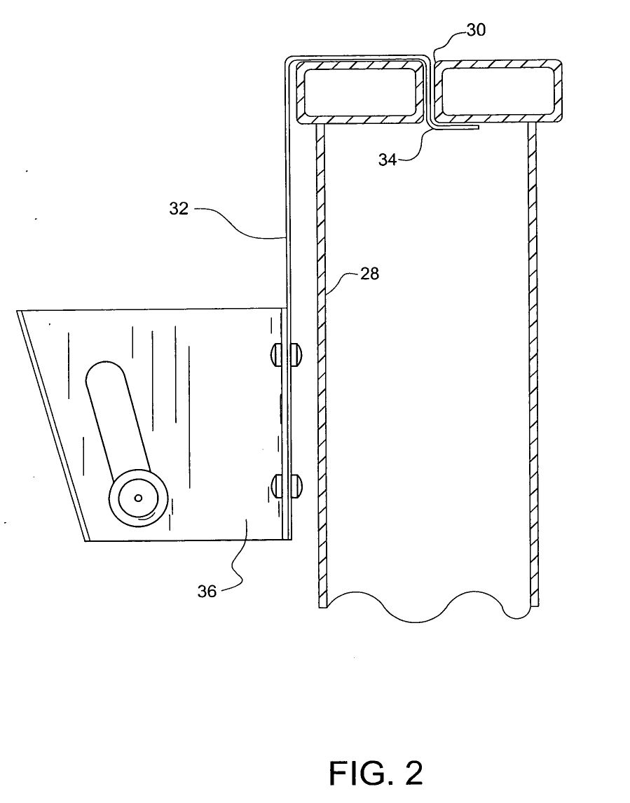

### DETAILED DESCRIPTION OF THE PREFERRED EMBODIMENTS

Referring to the drawings, there is illustrated a janitorial cleaning cart, generally indicated by reference numeral 10, comprising a main body including a lower portion 12 having ground engaging rear wheels 14, 14′, and front caster wheels 16, 16′; and a spaced apart upper portion 18 having a refuse bag retaining means including fasteners 20 disposed about an opening 22 defined by a top plate 24. The top plate 24 includes hand grips 26, 26′. The hand grips 26, 26′ are spaced apart and thereby provide a space for receiving the handle of a broom, for example, while the base of the broom would be supported by the upper surface of the lower portion 12.

The top plate 24 is maintained in spaced relation from the bottom or lower portion 12 of the cart 10 by a pair of spaced apart vertically extending uprights 28, 28′.

The top plate 24 is provided with a plurality of spaced slots 30 capable of receiving an accessory retaining attachment 32. The attachment 32 includes a supporting tab 34 configured to be selectively connected to the slots 30. The opposite end of the attachment 32 is provided with a bracket 36 for selectively connecting an accessory thereto. The bracket 36 may be a quick release holder for elongate objects such as, for example, brooms, brushes, mops, and the like. The bracket 36 typically includes a shallow U-shaped channel member adapted for horizontal attachment to a supporting plate as with threaded fasteners or rivets mounted to extend through holes adapted to mate and align with apertures in the channel member. The bracket 36 includes a vertically oriented wall, and a coacting roller element support on a captive shaft which, in turn, projects horizontally from the face of the channel and may move vertically at an angle in a slot in the force of the channel so as to move the roller closer to the vertical wall as the shaft end associated roller are caused to move downwardly in the slot.

The front of the top plate 24 may be provided with a slotted opening 38 which may be employed to retain the handle of a mop, for example, which is to be utilized in conjunction with a bracket supported on the upper surface of the lower portion 12.

While the cart 10 may be produced from a number of materials, it will be appreciated that plastic materials have been found to have many satisfactory characteristics.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A janitorial cleaning cart comprising:
a main body having a lower plate with ground engaging wheels and a spaced apart upper plate having a refuse bag retaining means and an associated receiving means for an accessory for removably maintaining cleaning supplies; and
an accessory retaining attachment including a supporting bracket for selectively connecting to the accessory to the accessory receiving means of the upper plate of the main body.

2. A janitorial cleaning cart as defined in claim 1 wherein the upper plate includes slots for receiving the supporting bracket.

3. A janitorial cleaning cart as defined in claim 2 wherein the supporting bracket includes a tab receivable within the slot.

4. A janitorial cleaning cart as defined in claim 3 wherein the bracket is formed to selectively retain the handle of a cleaning fixture.
